(19) United States
(12) Patent Application Publication
(10) Pub. No.: US 2026/0259883 A1
(43) Pub. Date: Sep. 3, 2026

(54) SYSTEMS AND METHODS FOR A PERSONALIZED SORTING ENGINE

(71) Applicant: Capital One Services, LLC, McLean, VA (US)

(72) Inventor: Rohan Vimal RAJ, Plano, TX (US)

(73) Assignee: Capital One Services, LLC, McLean, VA (US)

(21) Appl. No.: 19/066,810

(22) Filed: Feb. 28, 2025

(51) Int. Cl. G06F 16/2457; G06F 16/22; G06F 16/248

(52) U.S. Cl. CPC G06F 16/24578; G06F 16/2264; G06F 16/248

(57) ABSTRACT

Disclosed is a computer-implemented method that includes: receiving, from a user device, a search query comprising item data; obtaining, from at least one database, a user-specific embedding vector; modifying, based on the search query received from the user device, the user-specific embedding vector to generate an updated user-specific embedding vector; obtaining, from the at least one database, one or more item-specific embedding vectors based on the updated user-specific embedding vector, wherein the one or more item-specific embedding vectors are associated with one or more items; and causing an interface of the user device to display the one or more items associated with the one or more item-specific embedding vectors.

### TECHNICAL FIELD

Various embodiments of this disclosure relate generally to online searching techniques for sorting search results and, more particularly, to systems and methods for a personalized sorting of search results for online searching for non-fungible items.

### BACKGROUND

Various techniques for identifying and organizing search results are used in online searching. For example, gradient boosting machine (GBM) techniques (e.g., XGBRanker), logistic regression techniques, and deep learning models may be used in online searching applications, such as web search engines, document retrieval systems, and multimedia platforms. However, these techniques suffer from several issues. For example, the performance of logistic regression models may degrade when applied to complex target variable combinations. As another example, GBM ranker models may be difficult to implement and may need to be implemented on a machine-learning platform. Thus, conventional techniques, including the foregoing, may provide poor trade-offs between implementation difficulty and sorting accuracy. In addition, the conventional techniques may fail to provide accurate sorting (e.g., ordering) of search results based on predicted user preferences, in some circumstances, and may require intensive computation resources and time to generate personalized search recommendations. Furthermore, conventional techniques may fail to provide personalized search results that consider both a user's data history and a user's real-time search query.

This disclosure is directed to addressing one or more challenges such as the above. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for sorting search results and, more particularly, to systems and methods for a personalized sorting of search results for online searching for non-fungible items.

In one aspect, an exemplary embodiment of a computer-implemented method may include: receiving, from a user device, a search query comprising item data; establishes the item being searched; obtaining, from at least one database, a user-specific embedding vector; modifying, based on the search query received from the user device, the user-specific embedding vector to generate an updated user-specific embedding vector; obtaining, from the at least one database, one or more item-specific embedding vectors based on the updated user-specific embedding vector, wherein the one or more item-specific embedding vectors are associated with one or more items; and causing an interface of the user device to display the one or more items associated with the one or more item-specific embedding vectors.

In another aspect, an exemplary embodiment of a system may include: a user profile encoding model configured to generate a user-specific embedding vector associated with a user; an item embedding engine model configured to generate a plurality of item-specific embedding vectors associated with a plurality of items; and a computing system comprising: at least one database storing the user-specific embedding vector generated by the user profile encoding model and the plurality of item-specific embedding vectors generated by the item embedding engine model; at least one memory storing instructions; and at least one processor operatively connected to the at least one memory and configured to execute the instructions to perform operations. The operations may include: receiving, from a user device, a search query comprising item data; establishes the item being searched; obtaining, from at least one database, a user-specific embedding vector; modifying, based on the search query received from the user device, the user-specific embedding vector to generate an updated user-specific embedding vector; obtaining, from the at least one database, one or more item-specific embedding vectors based on the updated user-specific embedding vector, wherein the one or more item-specific embedding vectors are associated with one or more items; and causing an interface of the user device to display the one or more items associated with the one or more item-specific embedding vectors.

In a further aspect, an exemplary embodiment of a computer-implemented method may include: receiving, by one or more processors and from a user device, a search query comprising item data; obtaining, by the one or more processors and from at least one database, a multi-dimensional user-specific embedding vector comprising a plurality of values associated with a user; modifying, in real-time, by the one or more processors and based on the search query received from the user, the multi-dimensional user-specific embedding vector to generate an updated user-specific embedding vector; obtaining, by the one or more processors and from the at least one database, one or more item-specific embedding vectors based on the updated user-specific embedding vector, wherein the one or more item-specific embedding vectors were generated based on information associated with one or more items and according to a first predetermined schedule; and causing an interface of a user device to display one or more items associated with the one or more item-specific embedding vectors in an order determined by scores provided by an item sorting model, wherein the scores were generated by based on the information associated with the one or more items and according to a second predetermined schedule.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary embodiment of an environment for generating personalized sorting recommendations, according to one or more embodiments.

FIG. 2 illustrates an exemplary process for generating personalized sorting recommendations, according to one or more embodiments.

FIG. 3 depicts an exemplary embodiment of an environment for generating personalized sorting recommendations in greater detail, according to one or more embodiments.

FIG. 4 depicts a graphical representation of an exemplary system for generating vector embeddings, according to one or more embodiments.

FIG. 5 depicts an exemplary use of the system of FIG. 4 for correlating embedding vectors, according to one or more embodiments.

FIG. 6 illustrates a simplified functional block diagram of a computer system usable with various embodiments.

### DETAILED DESCRIPTION OF EMBODIMENTS

According to certain aspects of the disclosure, methods and systems are disclosed for generating personalized sorting recommendations by leveraging user-specific data attributes stored in one or more databases e.g., by obtaining, from at least one database, a user-specific embedding vector generated by a first user profile encoding model, and data attributes attributed to a user in a real-time search query by, and modifying, based on the real-time search query, the user-specific embedding vector to generate an updated user-specific embedding vector using a second user profile encoding model. The updated user-specific embedding vector may then be compared to one or more item-specific embedding vectors associated with the user's search query in a process to generate a personalized set of sorted recommendations of items for the user.

As will be discussed in more detail below, in various embodiments, systems and methods are described for generating personalized sorting recommendations, and in some aspects, using machine-learning to leverage real-time search queries to quickly and efficiently modify user-specific embedding vectors. Advantageously, item-specific embedding vectors and user-specific embedding vectors to be used in a search result sorting are updated according to a predetermined schedule independent of the receipt of a search query from a user. Upon receipt of a search query from the user, a stored user-specific embedding vector associated with the user is retrieved and modified in real-time based on data attributes contained within the search query. As such, the systems and methods disclosed herein improve the user experience, computational efficiency, and resource intensity associated with generating and displaying personalized sorting recommendations by reducing the amount of real-time computation necessary to generate an updated personalized sorting recommendation.

In some embodiments, the item-specific embedding vectors may be directed to specific vehicles associated with a vehicle identification number (“VIN”), and the user enters the search query on a website, mobile application, or the like, dedicated to searching for vehicles. More generally, the item-specific embedding vectors may be associated with other non-fungible items, such that each item in a set is accorded a unique item-embedding vector. This disclosure is not, however, limited to non-fungible items.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, or renting items to persons such as a seller, dealer, renter, merchant, vendor, or the like, as well as an agent or intermediary of such an entity or person. An “item” generally encompasses a good, service, or the like having ownership or other rights that may be transferred. As used herein, terms like “user” or “customer” generally encompasses any person or entity that may desire information, resolution of an issue, purchase of a product, or engage in any other type of interaction with a provider. An “interaction” generally encompasses an act or action involving transfer of an item between a provider and a user. The term “browser extension” may be used interchangeably with other terms like “program,” “electronic application,” or the like, and generally encompasses software that is configured to interact with, modify, override, supplement, or operate in conjunction with other software or devices.

As used herein, a “machine-learning model” generally encompasses instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration. By virtue of such training, a machine-learning model is converted from an un-trained and un-specific model to a model that is unique to and specifically configured for the particular purpose for which it is trained. In an example, training of a machine-learning model is analogous to a method of production in which the article produced is the trained model having unique characteristics by virtue of its particular training. Moreover, the result of training a machine-learning model using particular training data and for a particular purpose results in a technical solution to an inherently technical problem.

The execution of the machine-learning model may include deployment of one or more machine-learning techniques, such as linear regression, logistical regression, random forest, gradient boosted machine (GBM), deep learning, or a deep neural network. Supervised or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

Presented below are various aspects of machine-learning techniques that may be adapted to generating personalized sorting recommendations, e.g., by generating or retrieving user-specific embedding vectors and item-specific embedding vectors in response to a search query from the user. As will be discussed in more detail below, machine-learning techniques adapted to generating personalized sorting recommendations may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., or other aspects that may be apparent to one of ordinary skill in the art based on this disclosure.

In some embodiments, an encoding tensor may be used as a data structure for representing and processing information related to different vehicle categories. The tensor may be in the form of a 2D matrix where each entry corresponds to a particular vehicle category. Each entry in the matrix may contain a set of index values that are initially randomized and then updated during training to build associations between data characteristics such as, for example, vehicle types and the sequential ordering of vehicle types. By using this encoding tensor, it may be possible to efficiently encode and process large amounts of vehicle-related data for tasks such as classification, prediction, or recommendation.

One possible variation of this approach is to use a higher-dimensional tensor, such as a 3D, 4D, or other higher order tensor, to encode additional information about the vehicles or their attributes. For example, a 3D tensor could have one dimension for the vehicle category, another for one or more parameter of the vehicle, and a third which serves as index values. Another variation is to use different types of encoding methods, such as hashing, clustering, or embedding, to generate the index values for each entry in the encoding tensor. These variations may provide additional flexibility and power in representing and processing vehicle-related data for different applications.

In some embodiments, one or more encoding matrix may be utilized. The encoding matrix may be, in some embodiments, a tensor. The encoding matrix may initially be randomized with one or more value and subsequently trained to learn associations between one or more category, such as a category of vehicles, and/or one or more time-sequence-dependent associations between the same.

After training the index values of the 2D tensor, each entry in the tensor will have a set of index values that encode the associations between the vehicle categories and their sequential ordering. These index values can be used to cluster the vehicle categories based on their similarities.

One way to cluster the vehicle categories based on their similarities is to calculate the distance between the index values of each pair of entries in the tensor. Entries with similar index values will have a smaller distance between them, while entries with dissimilar index values will have a larger distance between them. The distance between each pair of entries can be plotted in a distance matrix or distance plot, where the entries with the smallest distance represent the most similar vehicle categories, and entries with the largest distance represent the most dissimilar vehicle categories.

Using this distance plot, it may be possible to identify clusters of vehicle categories that are most similar to each other based on their index values. These clusters can be used to group similar vehicles together and help in tasks such as classification or recommendation. For example, if a user searches for a specific type of vehicle, the system can use the trained tensor to find the cluster of vehicle categories that are most similar to the searched vehicle, and recommend vehicles from within that cluster.

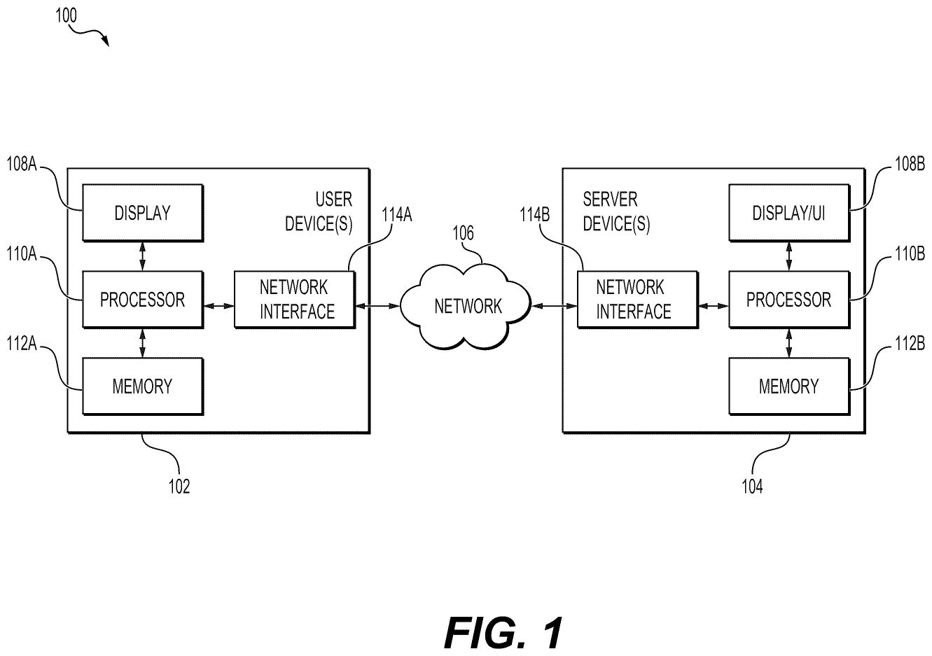

FIG. 1 depicts an exemplary environment 100 that may be utilized with techniques presented herein for generating personalized sorting recommendations, according to one or more embodiments. FIG. 1 depicts an exemplary environment 100 for recommended sorting of search results for online searching, according to one or more embodiments. The environment 100 may include one or more user devices 102, one or more server devices 104, and a network 106. Although FIG. 1 depicts a single user device 102, server device 104, and network 106, the embodiments described herein are applicable to environments 100 that include two or more user devices 102, server devices 104, and/or networks 106 in any suitable arrangement.

The user device 102 may include a display 108A, a processor 110A, a memory 112A, and/or a network interface 114A. The user device 102 may be a mobile device, such as a smartphone, a cell phone, a tablet, a laptop computer, etc., a desktop computer, and/or the like. The user device 102 may execute, by the processor 110A, one or more instructions stored in the memory 112A to, e.g., generate recommended sorting of search results, or train and/or use one or more machine-learning models to generate the recommended sorting, as described elsewhere herein. One or more components of the user device 102 may generate, or may cause to be generated, one or more graphic user interfaces (GUIs) based on instructions/information stored in the memory 112A, instructions/information received from the server device 104, and/or the like and may cause the GUIs to be displayed via the display 108A. The GUIs may be, e.g., mobile application interfaces or browser user interfaces and may include text, input text boxes, selection controls, and/or the like. The display 108A may include a touch screen or a display with other input systems (e.g., a mouse, keyboard, etc.) for an operator of the user device 102 to control the functions of the user device 102. The network interface 114A may be a transmission control protocol/Internet protocol (TCP/IP) network interface, or another type of wired or wireless communication interface, for Ethernet or wireless communications with the server device 104 via the network 106.

The server device 104 may include a display 108B, a processor 110B, a memory 112B, and/or a network interface 114B. The server device 104 may be a computer, system of computers (e.g., rack server(s)), or a cloud service computer system (e.g., in a data center). The server device 104 may execute, by the processor 110B, one or more instructions stored in the memory 112B to, e.g., generate recommended sorting of search results, or train and/or use one or more machine-learning models to generate the item-specific embedding vectors, to generate the user-specific embedding vectors, and to generate the recommended sorting, as described elsewhere herein. One or more components of the server device 104 may generate, or may cause to be generated, one or more graphic user interfaces (GUIs) based on instructions and/or information stored in the memory 112B, instructions/information received from the user device 102, and/or the like and may cause the GUIs to be displayed via the display 108B. The server device 104 may aggregate and store the generated embedding vectors in memory 112B or a separate database. The stored embeddings may be pre-cached and available for immediate retrieval in real-time during a search query generated by the user.

The network 106 may include one or more wired and/or wireless networks, such as the Internet, an intranet, a wide area network (“WAN”), a local area network (“LAN”), a personal area network (“PAN”), a cellular network (e.g., a 3G network, a 4G network, a 5G network, etc.) or the like. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “webpage” generally encompasses a location, data store, or the like that is, e.g., hosted and/or operated by a computer system so as to be accessible online, and that may include data configured to cause a program such as a web browser to perform operations such as send, receive, or process data, generate a visual display and/or an interactive interface, or the like. The user device 102 and the server device 104 may be connected via the network 106, using one or more standard communication protocols. The user device 102 and the server device 104 may transmit and receive messages from each other across the network 106, as discussed in more detail below.

As discussed in further detail below, the one or more components of exemplary environment 100 may process data from one or more user devices 102 and/or one or more server devices 104. Additionally, or alternatively, and as discussed in further detail below, the one or more components of exemplary environment 100 may generate, store, train and/or use a machine-learning model for generating recommended sorting of search results. The exemplary environment 100 or one of its components may include or be in operable communication with a machine-learning model and/or instructions associated with the machine-learning model, e.g., instructions for generating a machine-learning model, training the machine-learning model, using the machine-learning model, etc. The exemplary environment 100 or one of its components may include instructions for retrieving data, adjusting data, e.g., based on the output of the machine-learning model, and/or operating a display to output data, e.g., as adjusted based on the machine-learning model. The exemplary environment 100 or one of its components may include, provide, obtain, and/or generate training data.

In some embodiments, a system or device other than the components shown in the exemplary environment 100 may be used to generate and/or train the machine-learning model. For example, such a system may include instructions for generating and/or obtaining the machine-learning model, the training data and ground truth, and/or instructions for training the machine-learning model. A resulting trained-machine-learning model may then be provided to the exemplary environment 100 or one of its components and, for example, stored in the memory 112A and/or 112B.

Although depicted as separate components in FIG. 1, it should be understood that a component or portion of a component in the exemplary environment 100 may, in some embodiments, be integrated with or incorporated into one or more other components. For example, the server device 104 may be integrated in a data storage system. In some embodiments, operations or aspects of one or more of the components discussed above may be distributed amongst one or more other components. Any suitable arrangement and/or integration of the various systems and devices of the exemplary environment 100 may be used.

Further aspects of recommended sorting of search results or of the machine-learning model and/or how it may be trained or used to generate the recommended sorting are discussed in further detail below. In the following disclosure, various acts may be described as performed or executed by a component from FIG. 1, such as the user device 102, the server device 104, or components thereof. However, it should be understood that in various embodiments, various components of the exemplary environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable. In unsupervised learning, patterns, correlations, or clusters of input samples may be used to determine one or more metrics or features of the samples usable to differentiate between related subsets of the samples. In semi-supervised learning, unsupervised and supervised approaches may be combined.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training or used to validate the trained machine-learning model, e.g., compare the output of the trained model with the ground truth for that portion of the training data to evaluate an accuracy of the trained model. The training of the machine-learning model may be configured to cause the machine-learning model to learn associations between image data, context data, syntax data, etc., and identifications of particular alphanumeric characters, such that the trained machine-learning model is configured to determine an output alphanumeric character or sequence identification in response to the input image, context, syntax, or reflection pattern data or the like based on the learned associations.

In various embodiments, the variables of a machine-learning model may be interrelated in any suitable arrangement in order to generate the output. For example, in some embodiments, the machine-learning model may include image-processing architecture that is configured to identify, isolate, or extract features, geometry, and or structure in one or more of the medical imaging data or the non-optical in vivo image data. For example, the machine-learning model may include one or more convolutional neural network (“CNN”) configured to identify features in the image data, and may include further architecture, e.g., a connected layer, neural network, etc., configured to determine a relationship between the identified features in order to determine a location or pattern in the data.

In some instances, different samples of training data or input data may not be independent. For example, syntax, e.g., an order or pattern in a sequence of alphanumeric characters defined or limited by an underlying logic, may be associated with other aspects of an object. Thus, in some embodiments, the machine-learning model may be configured to account for or determine relationships between multiple samples.

For example, in some embodiments, one or more machine-learning models of the server devices 104 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model or Sequence to Sequence (“Seq2Seq”) model. An LSTM model may be configured to generate an output from a sample that takes at least some previous samples or outputs into account. A Seq2Seq model may be configured to, for example, receive a sequence of non-optical in vivo images as input, and generate a sequence of locations, e.g., a path, in the medical imaging data as output. Any suitable type of machine-learning model or combination of machine-learning models may be used, as described in further detail below. Operations conducted by one model in some embodiments may be distributed amongst a plurality of models in other embodiments, or vice versa.

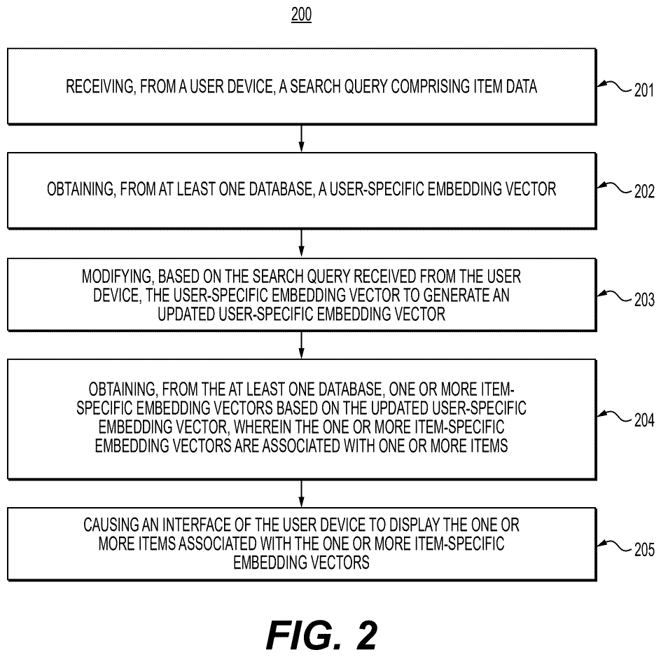

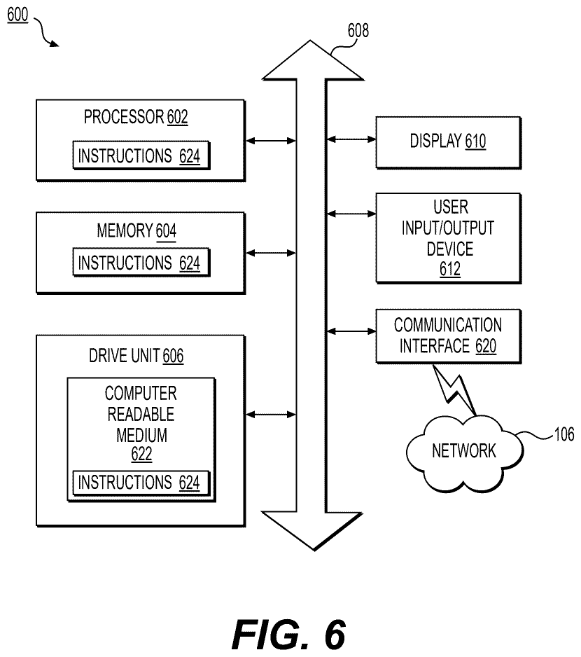

FIG. 2 is an exemplary flowchart of a computer-implemented or computer-based method for generating a personalized sorting of items based on user inputs. In one instance, the user devices 102 and server devices 104, alone or in combination, may perform one or more portions of the method 200 and are implemented using, for instance, a chip set including a processor (e.g., processor 602) and a memory (e.g., memory 604) as shown in FIG. 6. As such, the user devices 102 and server devices 104 may be configured to facilitate accomplishing various parts of the method 200, as well as accomplishing embodiments of other processes described herein. Although computer-implemented method 200 is illustrated and described as a sequence of actions, operations, and/or functionality, it is contemplated that various embodiments of the method 200 may be performed in any order or combination and need not include all of the illustrated actions, operations, and/or functionality.

In block 201, computer-implemented method 200 may include receiving, from a user device, a search query comprising item data. The search query may be received from the user device 102 via a website, desktop program, a browser program, a web client, or a mobile application program (which may also be a browser program in a mobile O/S), an applicant specific program, or the like.

In one example, a user may visit a website for searching vehicles for sale. The search query may be entered via pre-populated menus or via a plain text search from the user. The information provided by the user via the search query may include a plurality of parameters for a vehicle or VIN, such as new or used/pre-owned, mileage, make, model, trim, year, type of car (e. g,. sedan or sports utility vehicle (SUV) or sports car, etc.), features (e.g., four-wheel drive, leather interior, etc.), and other parameters known in the art. The search query may be entered as a text string or may be selected from specified drop-down menus. For example, a user may enter “2019 SUV like new,” or may select “2019” from a “year” drop-down menu, “SUV” from a “type of car” drop-down menu, and “like new” or “under 20,000 miles” from a “mileage” drop-down menu, for example.

In block 202, computer-implemented method 200 may include obtaining, from at least one database such as the server 104, a user-specific embedding vector. The user-specific embedding vector may include values indicating user-specific parameters and propensities. For example, where the system is targeted to users searching for cars, the user-specific embedding vector may include values that are correlated with a preference for luxury cars, correlated with outdoor lifestyles, correlated with a preference for pre-owned vehicles. In some embodiments, the user-specific embedding vector may incorporate data from the user's profile associated with a third party website. For example, if the user is a cardholder with a financial institution, the user's previous purchases using the card associated with the financial institution may be used to calculate at least a portion of the values in the user-specific embedding vector. In some embodiments, the search query may be entered in a website associated with a third party, and the user profile may be uploaded when the user logs in. If a user has not logged in, the user may be prompted to do so, upon which log-in a user-specific embedding vector may be obtained. The user-specific embedding vector may be generated manually, via an algorithm, or via a trained machine-learning model. The trained machine-learning model may be a first user profile encoding model. The user-specific embedding vector may be generated according to a predetermined schedule (e.g., once a day, once a week, etc.). As such, it need not be generated at the time of the user search query, only retrieved, saving valuable computation resources, and improving the speed of the retrieval, which improves the user experience of the search. The first user profile encoding model may receive as inputs data and data attributes associated with the user. For example, the first user profile encoding model may receive, from a third party database, such as that associated with a financial institution, data that may be associated with the user's preferences with regard to items for sale.

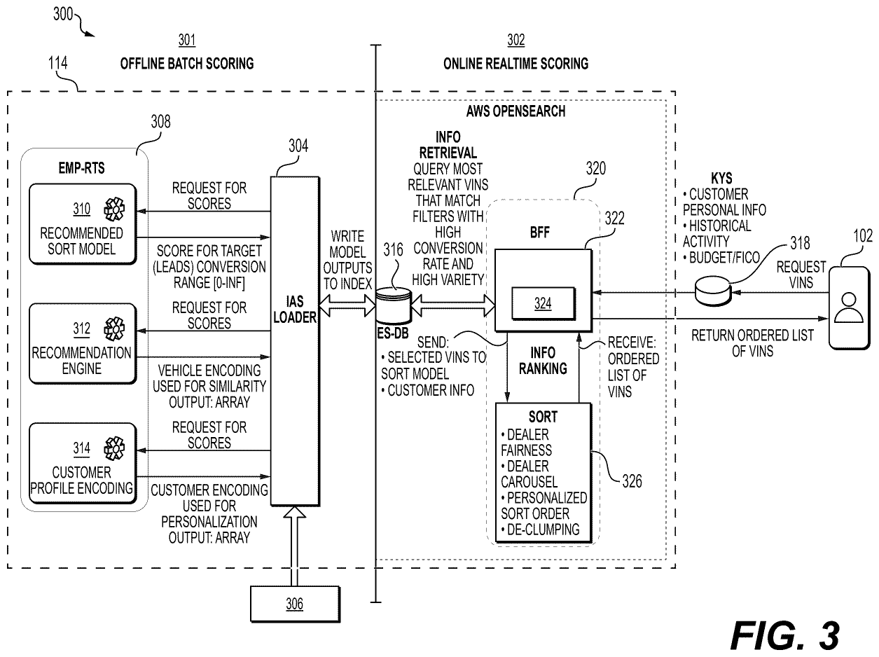

In block 203, computer-implemented method 200 may include modifying, based on the search query received from the user device, the user-specific embedding vector to generate an updated user-specific embedding vector. A user profile encoding model, described in more detail with respect to FIG. 3, may be configured to modify the user-specific embedding vector in real-time upon receipt of the search query from the user device.

Conventionally, a search query may be converted into an embedding in order to use machine-learning techniques to identify results matching the query, e.g., by finding result embeddings matching the embedding of the query. However, such conventional techniques may encounter challenges when faced with complex parameters. For example, it may be computationally costly or time consuming to generate a new embedding for a query, especially when parameters of the query are complex. Using pre-generated or pre-cached embeddings might reduce computing time or cost at runtime, but the this approach is ill suited to search queries, as it is unlikely that a particular search query would have been available prior to runtime. Further, a technique that generates a new embedding at runtime would conventionally involve a choice between increased compute cost and time to generate a new embedding that combines the query with additional data (e.g., user-specific data), or generating an embedding that does not account for the additional data. Thus, a solution that is able to account for additional data without sacrificing compute time and complexity at runtime would be beneficial.

In embodiments, the search query may be used to update the user-specific embedding vector. For example, if a user searches for “used 4wd suv, less than 100 k miles, under $25 k,” that search query may be used to update, e.g., in real-time, the user-specific embedding vector to account for the preferences indicated in the search. In other words, rather than generating a new embedding vector based on a combination of user-specific data and the search query, a pre-generated vector may instead be updated to account for a representation of the search query. In this manner, a modified vector that accounts for the user-specific data and the search query may be obtained without having to generate or re-generate a vector representation of the user-specific data.

In one example, the search query may be used to adjust one or more values of the user-specific embedding vector. For instance, the first user-profile encoding model may be used to generate an embedding of the search query, and the values in the embedding of the search query may be used as a weight factor applied to the values of the user-specific embedding vector. In another instance, one or more attention heads may be trained to learn associations between embeddings of search queries and user-specific embedding vectors. In a further instance, an embedding of the search query may be appended to the user-specific embedding vector. Thus, in some embodiments, an embedding that accounts for both the user-specific embedding vector and the search query may be obtained, whereby for example only the search query is embedded at runtime. In various embodiments, embeddings of search queries may be of similar or different dimensions as the user-specific embedding vectors.

In an example, the user-embedding specific vector may be updated to give greater values for vector parameters associated with, e.g., outdoor lifestyle, openness to used vehicles, preference for affordable vehicles, etc. As such, even if the user-specific embedding vector previously indicated higher values for luxury vehicles, new cars, and sports cars, the real-time update based on the search query would reflect the user's search query and modify the user-specific embedding vector to generate an updated user-specific embedding vector that gives, for example, greater values for used cars and SUVs.

The degree to which the original user-specific embedding vector is given weight and the search query is given weight may depend on a variety of factors and may be continually adjusted by the user profile encoding model as it is being trained. For example, if the amount of information used to generate the original user-specific embedding vector is substantial, the original user-specific embedding vector may be given substantially more weight than a single search query. In other examples, the user profile encoding model may be used to determine how relevant the original data is to the items being searched for, and modulate the amount of weight to be given to the original user-specific embedding vector based on that determination. In a further example, the weighting between the search query and the user-specific embedding vector may be a user-adjustable parameter, or may be a parameter that is adjusted based on user feedback or user behavior. For instance, if a user interacts with results that more closely align with one or the other, the weighting may be adjusted for future searches.

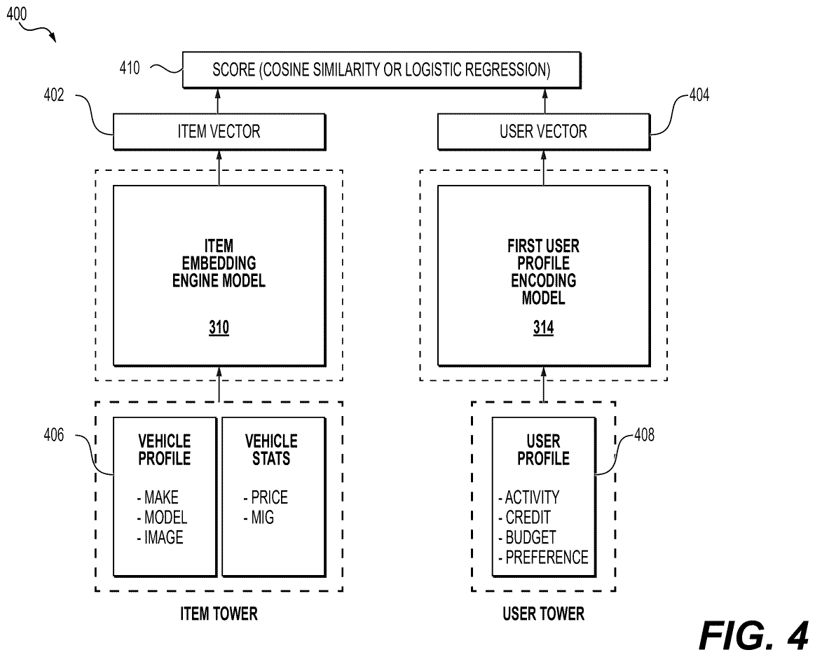

In block 204, computer-implemented method 200 may include obtaining, from the at least one database, one or more item-specific embedding vectors based on the updated user-specific embedding vector, wherein the one or more item-specific embedding vectors are associated with one or more items. The item-specific embedding vectors may be of similar dimension to the user-specific embedding vectors, and the values in the item-specific embedding vectors may correspond to the values in the user-specific embedding vectors. The item-specific embedding vectors may be generated manually, via an algorithm, or via a trained machine-learning model, and may be based on information associated with the one or more items. In some embodiments, the item-specific embedding vectors may embed one or more parameters of the items, as well as, in some embodiments, one or more parameters corresponding to one or more parameters of a search query embedding. The item-specific embedding vectors may be generated according to a predetermined schedule (e.g., once a day, once a week, etc.). As such, the item-specific embedding vectors need not be generated at the time of the user search query, only retrieved, saving valuable computation resources, and improving the speed of the retrieval, which improves the user experience of the search. As described in more detail with respect to FIG. 4, the item-specific embedding vectors may be obtained based on a cosine similarity score or logical regression score that determines a level of association between each of the one or more item-specific embedding vectors and the user-specific embedding vector.

In block 205, computer-implemented method 200 may include causing an interface of the user device 102 to display the one or more items associated with the one or more item-specific embedding vectors. In some examples, this may take the form of producing a search results page on the website, desktop program, browser program, web client, mobile application program or applicant specific program from which the search query was received.

FIG. 3 depicts an exemplary embodiment of an environment 300 for generating personalized sorting recommendations in greater detail, according to one or more embodiments. Environment 300 is similar to environment 100. Environment 300 includes offline systems 301 and real-time systems 302.

Server devices 114, as shown in FIG. 1, may include offline server devices such as an Internet Authentication Service (IAS) Loader 304. The IAS loader receives data comprising an inventory feed 306 and communicates with a server database 308 storing one or more models, including an item embedding engine model 310, an item sorting model 312, and a first user profile encoding model 314. The item embedding engine model 310 and the user profile encoding model 314 may each respectively include a transformer configured to convert text to numerical values, wherein the numerical values are processed and converted to one or more of the plurality of values for the multi-dimensional item-specific embedding vector and user-specific embedding vector, respectively.

Item embedding engine model 310 is configured to generate one or more item-specific embedding vectors based on information, or target variables, associated with the one or more items received from the inventory feed. Item sorting model 312 is configured to provide scores for each of the one or more items based on information associated with the one or more items. The scores may range, for example, from zero to an infinite value, or may be limited to a bound range. First user profile encoding model 314 is configured to generate a user-specific embedding vector.

As discussed above, the item-specific embedding vector, the user-specific embedding vector, and further the item scores may be generated according to a predetermined schedule (e.g., once a day, once a week, etc.). As such, the item-specific embedding vectors, the user-specific embedding vector, and the item scores need not be generated at the time of the user search query, only retrieved from a database, saving valuable computation resources, and improving the speed of the retrieval, which improves the user experience of the search.

Upon receipt of a search query from a user via user device 102 for an item or a subset of items, the item-specific embedding vectors, the user-specific embedding vector, and the item scores may be retrieved from IAS loader 304 and stored in elastic search database (“ES-DB”) 316. Upon receipt of the search query, a tracking ID may be associated with a particular user that may capture and store user behavior activity when visiting a website associated with a specific item, such as a specific vehicle and/or VIN. The tracking mechanism may be implemented using various methods known in the art, including the use of cookies or other tracking technologies, and may be stored in a cache 318 in the memory 112A of the user device 102. For example, a sequential order of user behaviors and vehicle/VIN visits allows for the creation of a comprehensive user activity history, which can be analyzed to provide insights into user behavior and preferences. By storing and analyzing user behavior, the system can track the user's journey as they interact with a website and engage with different vehicles/VINs. For example, the system can track when a user first visits the website, which vehicles/VINs they initially view, and which vehicles/VINs they ultimately purchase or lease, and/or what categories the vehicles/VINs belong to.

At a backend-for-frontend (“BFF”) 320, a micro-frontend (“MFE”) 322 receives the search query and other personal information from cache 318. MFE 322 likewise retrieves the user-specific embedding vector from ES-DB 316 that was generated by the first user profile encoding model 314. A second user profile encoding model 324, in some embodiments stored on MFE 322, uses the search query and other personal information from cache 318 to modify the user-specific embedding vector to generate an updated user-specific embedding vector, as described above with reference to FIG. 2.

MFE 322 also retrieves, from ES-DB 316, the most relevant items that match the updated user-specific embedding vector, filtered for matches with high conversion rates and high variety. MFE 322 then sends select items to a sorting model 326 that is configured to provide the personalized sort order based on the item scores generated by item sorting model 314. In some examples, the items may be vehicles, and the output from the sorting model 326 may be an ordered list of VINs with item-specific embedding vectors that best match the updated user-specific embedding vector.

FIG. 4 depicts a graphical representation of an exemplary system 400 for generating and correlating item-specific vector embeddings 402 and user-specific vector embeddings 404, according to one or more embodiments. In the example shown in FIG. 4, the system is directed to generating vector embeddings for vehicles in an item embedding engine model 310, and generating user embeddings for users in a user profile encoding model 314. Where the one or more items includes a plurality of vehicles, and each of the one or more item-specific embedding vectors is a vehicle-specific embedding vector 402 associated with a vehicle having a unique vehicle identification number (VIN). Each of the one or more item-specific embedding vectors may be a multi-dimensional item-specific embedding vector comprised of a plurality of values, one or more of the plurality of values being based on one or more of a make, a model, mileage, condition, location, or price of the vehicle, among other factors. The user-specific embedding vector is a multi-dimensional user-specific embedding vector of equal dimension to each of the one or more item-specific embedding vectors.

In the example for vehicle VINs, the item embedding engine model may be utilized to encode all vehicle types, and may be utilized to capture similarities between one or more vehicle types. To achieve this, a similarity matrix (or tensor matrix) may be formed which establishes indexed values associated with each vehicle type id (potential encoded input). For example, vehicle inputs 406 such as make and model of the vehicle, an image of the vehicle, price, mileage, etc., may be input to the indices of the tensor to produce an item-specific embedding vector. The structure of the matrix may be representable in a row-column format, where each row represents a potential encoded input and each column represents an index value. In some embodiments, the structure may be that of a tensor matrix. A tensor, in some embodiments, is a mathematical object that represents a multi-dimensional array of numerical values. In particular, a tensor can be thought of as a generalization of a matrix to higher dimensions. In some embodiments, a 2D tensor comprises a rectangular grid of numerical values, where each element is identified by its row and column indices. In one embodiment, the 2D tensor may be represented using a nested list. The nested list may comprise a series of sub-lists, each of which corresponds to a row of the tensor. Within each sub-list, the numerical values corresponding to the elements of the row may be listed in order. The row and column indices of each element may be determined by its position within the nested list. The 2D tensor may also be visualized as a matrix or grid, where each row and column corresponds to a particular dimension of the tensor. This visualization may make it easy to see the structure of the tensor and to perform operations such as matrix multiplication and transposition.

Prior to training, the matrix may be initiated randomly, such that each index value is generated randomly. During training, the index values are updated via reinforcement training to capture associations between different vehicle type ids and between sequentially linked (index specific) associations between the same. The post-trained index then is representative of associations between different vehicle type ids and/or between sequential associations between vehicle type ids. For example, if two vehicles frequently occur together in a specific sequence, the index values for those vehicles in the encoding matrix may be updated (by way of training a machine-learning model) to reflect this association. This may enable the encoding matrix to capture complex associations and relationships between different vehicle types that may not be immediately obvious.

After the training process, the encoding matrix can be used for various applications such as clustering, prediction, or recommendation. For example, the trained encoding matrix can be used to cluster vehicles based on their similarities, or to predict the likelihood of a user buying a certain vehicle based on previous user behaviors. It can also be used to recommend vehicles to users based on their preferences, prior user behaviors, or other data associated with the user.

Similarly, first user profile encoding model 314 may be trained based on a trained tensor matrix, where prior to training, the matrix may be initiated randomly, such that each index value is generated randomly. During training, the index values are likewise updated via reinforcement training to capture associations between different users. This may enable the encoding matrix to capture complex associations and relationships between user data and attributes and to produce more accurate user-specific embedding vectors.

Lastly, a matching element 410 of the system may be configured to match one or more item-specific embedding vectors 402 to a user-specific embedding vector 404 based on the index values in the embedding vectors. In various embodiments, any suitable matching process may be used. In an example, the system may include a cosine similarity engine, a k-nearest neighbor engine, or the like.

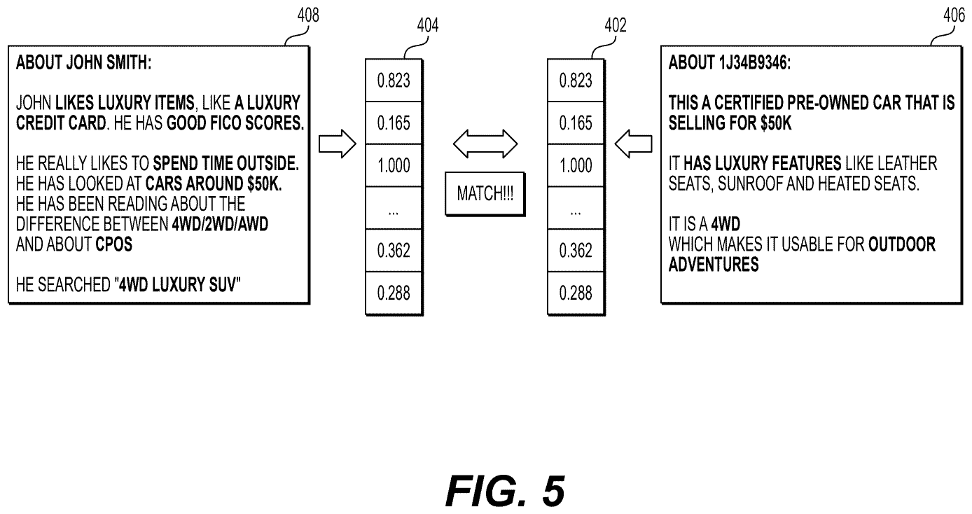

FIG. 5 depicts an exemplary use of the system 400 of FIG. 4 for correlating or matching embedding vectors in more detail, according to one or more embodiments. An item-specific embedding vector 402 may be matched with a user-specific embedding vector 404 based on item-specific inputs 406 and user-specific inputs 408. For example, the item-specific inputs 406 may be associated with vehicle with VIN “1J34B9346” which is a certified pre-owned vehicle selling for $50,000. It has luxury features, such as leather seats, a sunroof, and heat seats. It is a four-wheel drive vehicle usable for outdoor adventures. The user-specific inputs 408 for user “John Smith” may indicate that he likes luxury items, including use of a luxury credit card, and has good credit scores. His user profile indicates that he likes to spend time outside (e.g., purchase history may be associated with outdoor activities, etc.), and that his prior vehicle searches included cars selling for around $50,000. Furthermore, his browser search history may include searches for articles explaining the difference between four-wheel drive and two-wheel drive, and searches for “certified pre-owned” vehicles. Lastly, the user-specific embedding vector 404 may be updated based on his search for “4WD luxury SUV.” The generated user-specific embedding vector 404 is of equal dimension to the item-specific embedding vector 402, and includes values that are substantially identical for the user and the VIN described, based on these inputs.

A graphical user interface may display one or more recommended vehicle to a user. The vehicle recommendations may be in the form of a single vehicle recommendation, but in some embodiments the vehicle recommendations are shown in a row-column grid arrangement. In some embodiments, the top row of the grid arrangement may include a category-and/or filter-agnostic recommendation of vehicles, which may be determined based on a vehicle recommendation score and/or vehicle recommendation category. Within the columns in the first row (and, in some embodiments, in subsequent rows), individual vehicles are displayed in descending recommended order, where the most highly recommended vehicle is placed on one side of the grid arrangement, the second highest recommended vehicle is placed in the next column, and so on. Once again, the recommendation of the vehicle may be determined by a vehicle recommendation score derived from the machine-learning model and/or associations between vehicles types that may be similar to the recommended vehicle type based on the output of the model.

Similarly, each descending row may be associated with one or more categorical filter and/or category associated with vehicle in the inventory. For example, the second row may be related to a category (dynamically adjusted or otherwise) which is similar to that output by the model, or in some embodiments it may be the category with the shortest distance based on the vector average and the plot demonstrating vehicle categorical associations and similarities. In some embodiments, the 2nd row will be representative of a vehicle category which is similar to one or more user interest and/or behavior, and each subsequent row will be representative of vehicle categories which have decreasing relevancy to the user. As discussed above, within each category, vehicles are displayed which match the categorical filters and displayed in descending order of relevance and/or recommendation to the user. In this manner, the system may flexibly display vehicles which are both relevant to the user (based on the categorical filters and/or dynamic categorization) and are recommended to the user within each row a relevancy. Advantageously, this is unique tailor to each user based on their prior search histories along with relevant vehicle inventories for the user, such an inventories which are within a particular geographic search range. In some embodiments, the data provided to the user within the grid may be considered a first dataset, and the first dataset may be generated at least in part off of the output of one or more machine-learning model.

FIG. 6 illustrates a simplified functional block diagram of a computer system usable with various embodiments. FIG. 6 is a simplified functional block diagram of a computer 600 that may be configured as a device for executing processes described in FIGS. 2-5, according to exemplary embodiments of the present disclosure. For example, the computer 600 may be configured as the user device 102, the server device 104, or another system according to exemplary embodiments of this disclosure. In various embodiments, any of the systems herein may be a computer 600 including, for example, a data communication interface 620 for packet data communication. The computer 600 also may include a central processing unit (“CPU”) 602, in the form of one or more processors, for executing program instructions. The computer 600 may include an internal communication bus 608, and a storage unit 606 (such as ROM, HDD, SDD, etc.) that may store data on a computer readable medium 622, although the computer 600 may receive programming and data via network communications. The computer 600 may also have a memory 604 (such as RAM) storing instructions 624 for executing techniques presented herein, although the instructions 624 may be stored temporarily or permanently within other modules of computer 600 (e.g., processor 602 or computer readable medium 622). The computer 600 also may include input and output ports 612 or a display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

1. A computer-implemented method comprising:
receiving, from a user device, a search query comprising item data;
obtaining, from at least one database, a user-specific embedding vector;
modifying, based on the search query received from the user device, the user-specific embedding vector to generate an updated user-specific embedding vector, wherein modifying the user-specific embedding vector comprises adjusting one or more values of the user-specific embedding vector based on the search query;
obtaining, from the at least one database, one or more item-specific embedding vectors based on the updated user-specific embedding vector, wherein the one or more item-specific embedding vectors are associated with one or more items; and
causing an interface of the user device to display the one or more items associated with the one or more item-specific embedding vectors.

2. The computer-implemented method of claim 1, wherein:
an item embedding engine model is configured to generate the one or more item-specific embedding vectors based on information associated with the one or more items and according to a predetermined schedule; and
a user profile encoding model is configured to modify the user-specific embedding vector in real-time upon receipt of the search query from the user device.

3. The computer-implemented method of claim 2, wherein the user profile encoding model has been trained to output the user-specific embedding vector based on one or more user data attributes of a user associated with the user device.

4. The computer-implemented method of claim 2, wherein the item embedding engine model has been trained to output a respective item-specific embedding vector for each of the one or more items based on one or more target variables associated with each of the one or more items.

5. The computer-implemented method of claim 1, wherein:
an item sorting model is configured to provide scores for each of the one or more items based on information associated with the one or more items and according to a predetermined schedule;
an order of display is determined by the item sorting model based on the scores; and
a user profile encoding model is configured to modify the user-specific embedding vector in real-time upon receipt of and based on the search query from the user device.

6. The computer-implemented method of claim 1, wherein the one or more items includes a plurality of vehicles, and each of the one or more item-specific embedding vectors is a vehicle-specific embedding vector associated with a vehicle having a unique vehicle identification number (VIN).

7. The computer-implemented method of claim 6, wherein each of the one or more item-specific embedding vectors is a multi-dimensional item-specific embedding vector comprised of a plurality of values, one or more of the plurality of values being based on one or more of a make, a model, mileage, condition, location, or price of the vehicle.

8. The computer-implemented method of claim 7, wherein the user-specific embedding vector is a multi-dimensional user-specific embedding vector of equal dimension to each of the one or more item-specific embedding vectors.

9. A system comprising:
a user profile encoding model configured to generate a user-specific embedding vector associated with a user;
an item embedding engine model configured to generate a plurality of item-specific embedding vectors associated with a plurality of items; and
a computing system comprising:
at least one database storing the user-specific embedding vector generated by the user profile encoding model and the plurality of item-specific embedding vectors generated by the item embedding engine model;
at least one memory storing instructions; and
at least one processor operatively connected to the at least one memory and configured to execute the instructions to perform operations, including:
receiving, from a user device, a search query comprising item data;
obtaining, from the at least one database, the user-specific embedding vector;
modifying the user-specific embedding vector based on the search query received from the user device to generate an updated user-specific embedding vector, wherein modifying the user-specific embedding vector comprises adjusting one or more values of the user-specific embedding vector based on the search query;
receiving, from the at least one database and based on the updated user-specific embedding vector, one or more item-specific embedding vectors of the plurality of item-specific embedding vectors; and
causing an interface of the user device to display the one or more items associated with the one or more item-specific embedding vectors.

10. The system of claim 9, wherein:
the item embedding engine model is configured to generate the plurality of item-specific embedding vectors based on information associated with the one or more items and according to a predetermined schedule; and
the user profile encoding model is configured to modify the user-specific embedding vector in real-time upon receipt of the search query from the user.

11. The system of claim 9, further comprising:
an item sorting model configured to provide scores for each of the plurality of items at predetermined times based on a predetermined schedule; and wherein:
the user profile encoding model is configured to modify the user-specific embedding vector in real-time upon receipt of and based on the search query from the user.

12. The system of claim 9, wherein the item embedding engine model has been trained to output a respective item-specific embedding vector for each of the plurality of items based on one or more target variables associated with the plurality of items.

13. The system of claim 12, wherein each of the item-specific embedding vectors is a multi-dimensional item-specific embedding vector comprised of a plurality of values, and wherein the item embedding engine model includes a transformer configured to convert text to numerical values, wherein the numerical values are processed and converted to one or more of the plurality of values for the multi-dimensional item-specific embedding vector.

14. The system of claim 12, wherein:
the user profile encoding model has been trained to output the user-specific embedding vectors for each of a plurality of users based on one or more user data attributes associated with the plurality of users;
each of the user-specific embedding vectors is a multi-dimensional user-specific embedding vector comprised of a plurality of values; and
the user profile encoding model includes a transformer configured to convert text to numerical values, wherein the numerical values are processed and converted to one or more of the plurality of values for the multi-dimensional user-specific embedding vector.

15. The system of claim 9, wherein the plurality of items includes a plurality of vehicles, and each of the one or more item-specific embedding vectors is a vehicle-specific embedding vector associated with a vehicle having a unique vehicle identification number (VIN).

16. The system of claim 15, wherein each of the one or more item-specific embedding vectors is a multi-dimensional item-specific embedding vector comprised of a plurality of values, one or more of the plurality of values being based on one or more of a make, a model, mileage, condition, location, or price of the vehicle.

17. The system of claim 16, wherein the user-specific embedding vector is a multi-dimensional user-specific embedding vector of equal dimension to each of the one or more item-specific embedding vectors.

18. A computer-implemented method comprising:
receiving, by one or more processors and from a user device, a search query comprising item data;
obtaining, by the one or more processors and from at least one database, a multi-dimensional user-specific embedding vector comprising a plurality of values associated with a user;
modifying, in real-time, by the one or more processors and based on the search query received from the user, the multi-dimensional user-specific embedding vector to generate an updated user-specific embedding vector, wherein modifying the user-specific embedding vector comprises adjusting one or more values of the user-specific embedding vector based on the search query;
obtaining, by the one or more processors and from the at least one database, one or more item-specific embedding vectors based on the updated user-specific embedding vector, wherein the one or more item-specific embedding vectors were generated based on information associated with one or more items and according to a first predetermined schedule; and
causing an interface of a user device to display one or more items associated with the one or more item-specific embedding vectors in an order determined by scores provided by an item sorting model, wherein the scores were generated by based on the information associated with the one or more items and according to a second predetermined schedule.

19. The computer-implemented method of claim 18, wherein the one or more items includes a plurality of vehicles, and each of the one or more item-specific embedding vectors is a vehicle-specific embedding vector associated with a vehicle having a unique vehicle identification number (VIN).

20. The computer-implemented method of claim 19, wherein:
each of the one or more item-specific embedding vectors is a multi-dimensional item-specific embedding vector comprised of a plurality of values, one or more of the plurality of values being based on one or more of a make, a model, mileage, condition, location, or price of the vehicle; and
the updated user-specific embedding vector is a multi-dimensional user-specific embedding vector of equal dimension to each of the one or more item-specific embedding vectors.
